(19) United States
(12) Patent Application Publication
(10) Pub. No.: US 2026/0360648 A1
(43) Pub. Date: Nov. 12, 2026

(54) RELAY

(71) Applicant: Xiamen Hongfa Electric Power Controls Co., Ltd., Xiamen, Fujian (CN)

(72) Inventors: Wenguang DAI, Xiamen, Fujian (CN); Meng WANG, Xiamen, Fujian (CN); Liji SU, Xiamen, Fujian (CN); Songsheng CHEN, Xiamen, Fujian (CN)

(21) Appl. No.: 19/120,840

(22) PCT Filed: Oct. 11, 2023
(86) PCT No.: PCT/CN2023/124058

§ 371 Date: Apr. 14, 2025

(30) Foreign Application Priority Data
Oct. 12, 2022 (CN) 202211248733.8

(51) Int. Cl. H01H 50/42; H01H 50/04; H01H 50/16; H01H 50/30; H01H 50/60; H01H 50/64

(52) U.S. Cl. CPC H01H 50/42; H01H 50/041; H01H 50/163; H01H 50/30; H01H 50/60; H01H 50/648

(57) ABSTRACT

A relay includes a contact container having a contact chamber; a pair of static contact terminals; a first magnetizer located within the contact chamber and including a connecting portion and a magnetic portion connected to the connecting portion; a push rod assembly including a push rod and a second magnetizer arranged at one end of the push rod, the second magnetizer is offset from the magnetic portion and corresponds to the connecting portion; and a movable contact assembly movably disposed relative to the push rod assembly, between a first position and a second position, and including a movable contact piece and a third magnetizer. Wherein the third and first magnetizers form a first magnetic circuit, and the third and second magnetizers form a second magnetic circuit. The distance between the third magnetizer and the connecting portion is greater than the distance between the third magnetizer and the magnetic portion.

### CROSS-REFERENCE

This disclosure is the U.S. national phase application of International Application No. PCT/CN2023/124058, filed on Oct. 11, 2023, which claims priority to Chinese patent application No. 202211248733.8 filed on Oct. 12, 2022, titled “Relay”, the entire contents of which are incorporated herein by reference.

### TECHNICAL FIELD

The present disclosure relates to a relay.

### BACKGROUND

A relay is an electronic control device that consists of a control system (also known as the input circuit) and a controlled system (also known as the output circuit). It is commonly used in automatic control circuits. Essentially, a relay functions as an “automatic switch” that uses a smaller current to control a larger current. As such, it plays roles in automatic regulation, safety protection, and circuit switching within electrical systems.

High-voltage DC relays are a type of relay. In order to solve the problem that the contact of high voltage DC relay bounces off because of the electric repulsion generated by short circuit current, related technologies typically employ an anti-short-circuit ring electromagnetic structure. Based on the placement of the upper yoke iron, these structures are further categorized into follow-up type and fixed type. Specifically, the follow-up type structure refers that the upper yoke iron is installed on the movable component of the relay, while the fixed type structure refers that the upper yoke iron is installed in a fixed position other than the movable component. However, although the fixed-type anti-short-circuit structure has strong anti-short-circuit capability, its breaking capacity is weakened due to the negative correlation between anti-short-circuit capability and breaking capacity. On the other hand, the follow-up type anti-short-circuit structure is influenced by the holding force of the movable iron core. When the short-circuit current is high, the iron core will break off, which will lead to the disconnection of contacts, and to increase the holding force of the moving iron core, it is necessary to increase the coil, which is contrary to the small size and light weight.

### SUMMARY

In one aspect of the present disclosure, a relay including:
a contact container having a contact chamber;
a pair of static contact terminals fixedly disposed relative to the contact container;
a first magnetizer located within the contact chamber; the first magnetizer includes a connecting portion and a magnetic portion connected to the connecting portion, and the first magnetizer is fixed relative to the contact container through the connecting portion;
a push rod assembly, including a push rod and a second magnetizer; the push rod is movably disposed relative to the contact container along an axial direction of the push rod, and the second magnetizer is arranged at one end of the push rod; along the axial direction of the push rod, the second magnetizer is offset from the magnetic portion and corresponds to the connecting portion;
a movable contact assembly, movably disposed relative to the push rod assembly along the axial direction of the push rod, between a first position closer to the static contact terminals and a second position farther from the static contact terminals; the movable contact assembly includes a movable contact piece and a third magnetizer; the first magnetizer and the second magnetizer are located at a side of the movable contact piece facing the static contact terminals, and along the axial direction of the push rod, the third magnetizer is fixedly disposed at a side of the movable contact piece facing away from the first magnetizer and the second magnetizer; the third magnetizer and the first magnetizer are configured to form a first magnetic circuit, and the third magnetizer and the second magnetizer are configured to form a second magnetic circuit; a distance between the third magnetizer and the connecting portion is greater than a distance between the third magnetizer and the magnetic portion.

According to some embodiments of the present disclosure, wherein the pair of static contact terminals are connected to the contact container, at least a portion of each of the static contact terminals is located within the contact chamber.

According to some embodiments of the present disclosure, the relay further including an elastic member connected between the movable contact assembly and the push rod assembly, configured to apply an elastic force to the movable contact assembly toward the first position.

According to some embodiments of the present disclosure, the magnetic portion and the connecting portion are of an integrated structure, and the magnetic portion extends from the connecting portion toward the movable contact piece.

According to some embodiments of the present disclosure, the first magnetizer includes two magnetic portions arranged oppositely, the two magnetic portions are respectively connected to two sides of the connecting portion along the length direction of the movable contact piece, forming the first magnetizer in an inverted U-shape.

According to some embodiments of the present disclosure, when the movable contact assembly is in the first position, a magnetic gap between the magnetic portion and the third magnetizer is greater than a magnetic gap between the second magnetizer and the third magnetizer.

According to some embodiments of the present disclosure, when the movable contact assembly is in the first position, the second magnetizer and the third magnetizer are in direct contact.

According to some embodiments of the present disclosure, the push rod assembly further includes a support seat fixed at one end of the push rod along the axial direction of the push rod and at least partially extending into the contact chamber; the second magnetizer is fixed to the support seat, and the elastic member is arranged between the movable contact assembly and the support seat.

According to some embodiments of the present disclosure, the support seat includes:
a base connected to one end of the push rod, the elastic member is arranged between the base and the movable contact assembly; and
a bracket connected to the base; the second magnetizer is connected to an inner wall surface of the bracket, and the movable contact piece and the third magnetizer are movably arranged within a space enclosed by the base and the bracket.

According to some embodiments of the present disclosure, the bracket includes:
a top portion, the second magnetizer is connected to an inner wall surface of the top portion; and
two side portions respectively connected to two sides of the top portion and extending from the top portion toward the base; two ends of the two side portions away from the top portion are respectively connected to the base, and the two side portions, the top portion, and the base together form a space for the movable contact assembly to move.

According to some embodiments of the present disclosure, the contact container further includes a pair of first through-holes and a second through-hole communicating with the contact chamber; the pair of static contact terminals respectively pass through the pair of first through-holes in one-to-one correspondence;
the relay further includes a connector passed through the second through-hole, the connector includes a first end and a second end, the first end is connected to the contact container, and the second end is connected to the connecting portion.

According to some embodiments of the present disclosure, the contact container includes:
a yoke plate; and
an insulating cover including a top wall and a side wall, one end of the side wall is connected around the perimeter of the top wall, and another end of the side wall is connected to the yoke plate;
wherein the first through-holes and the second through-hole are provided in the top wall, and the first end of the connector is connected to an outer surface of the top wall.

According to some embodiments of the present disclosure, the insulating cover includes a ceramic cover and a frame member, the ceramic cover includes the top wall and the side wall, another end of the side wall is connected to the yoke plate through the frame member;
on an outer surface of the top wall, a first metallization layer is provided around a periphery of the first through-holes, and a second metallization layer is provided around a periphery of the second through-hole;
the static contact terminals are welded to the top wall through the first metallization layer, and the first end of the connector is welded to the top wall through the second metallization layer.

According to some embodiments of the present disclosure, the top wall and the side wall are of an integrated structure; or, the top wall and the side wall are separate structures.

According to some embodiments of the present disclosure, wherein the connecting portion has a connecting hole, and the connector passes through the connection hole.

According to some embodiments of the present disclosure, the connecting portion is spaced apart from an inner surface of the top wall.

According to some embodiments of the present disclosure, the contact container includes:
a yoke plate; and
an insulating cover connected to the yoke plate;
the relay further includes a fixed frame located within the contact chamber and fixed to the yoke plate, and the connecting portion is fixed to the fixed frame.

### BRIEF DESCRIPTION OF THE DRAWINGS

The above and other features and advantages of the present disclosure will become more apparent by describing in detail exemplary embodiments with reference to the accompanying drawings.

FIG. 1 shows a perspective view of the relay of the present disclosure.

FIG. 2 shows a schematic view of FIG. 1 with the ceramic cover and frame member removed.

FIG. 3 shows a top view of FIG. 1.

FIG. 4 shows a cross-sectional view along line A-A in FIG. 3.

FIG. 5 shows an exploded view of FIG. 1.

FIG. 6 shows a cross-sectional view along line B-B in FIG. 3, with the ceramic cover, the frame member, and the connector removed, and overtravel is completed.

FIG. 7 shows a cross-sectional view along line C-C in FIG. 3, with the ceramic cover, frame member, and the connector removed, and overtravel is completed.

FIG. 8 shows a cross-sectional view along line A-A in FIG. 3, with the ceramic cover, the frame member, and the connector removed, and overtravel is completed.

FIG. 9 shows a cross-sectional view along line B-B in FIG. 3, with the ceramic cover, the frame member, and the connector removed, and when the movable contact piece just contacts or separates from the static contact terminal.

FIG. 10 shows a cross-sectional view along line C-C in FIG. 3, with the ceramic cover, the frame member, and the connector removed, and when the movable contact piece just contacts or separates from the static contact terminal.

FIG. 11 shows a cross-sectional view along line A-A in FIG. 3, with the ceramic cover, the frame member, and the connector removed, and when the movable contact piece just contacts or separates from the static contact terminal.

FIG. 12 shows an exploded view of the relay according to an embodiment of the present disclosure.

### REFERENCE NUMERALS

10. contact container; 101. contact chamber; 102. first through-hole; 103. second through-hole; 11a. insulating cover; 11. ceramic cover; 111. top wall; 112. side wall; 113. first metallization layer; 114. second metallization layer; 12. frame member; 13. yoke plate; 131. third through-hole; 20. static contact terminal; 30. connector; 31. first end of the connector; 32. second end of the connector; 40. first magnetizer; 410. connecting portion; 420. magnetic portion; 50. push rod assembly; 51. push rod; 52. support seat; 521. base; 522. bracket; 523. top portion; 524. side portion; 53. movable contact assembly; 54. movable contact piece; 55. third magnetizer; 56. elastic member; 60. second magnetizer; 1100. housing; 1110. first housing; 1120. second housing; 1130. exposure hole; 1200. electromagnet unit; 1210. bobbin; 1220. coil; 1240. movable iron core; 1250. reset member; 1300. arc extinguishing unit; 1310. arc extinguishing magnet; 1320. yoke clip; 1400. sealing unit; 1410. metal cover; D1. movement direction; D2. length direction.

### DETAILED DESCRIPTION

The exemplary embodiments will now be described more comprehensively with reference to the accompanying drawings. However, the exemplary embodiments can be implemented in various forms and should not be construed as limited to the embodiments described herein. Although relative terms such as “upper” and “lower” are used in this specification to describe the relative relationship of one component to another in the figures, these terms are used in this specification for convenience only, such as according to the orientation of the examples in the drawings. It is understood that if the device in the figures is flipped upside down, the component described as “upper” will become “lower.” Other relative terms such as “top” and “bottom” also have similar meanings. When a structure is “on” another structure, it may mean that the structure is integrally formed on the other structure, or that the structure is “directly” placed on the other structure, or that the structure is “indirectly” placed on the other structure through another structure.

The terms “a” “an” “the” and “said” are used to indicate the presence of one or more elements/components/etc. The terms “include” and “have” are used to indicate an open-ended inclusion and mean that in addition to the listed elements/components/etc., there may be additional elements/components/etc. The terms “first” “second” etc., are used only as labels and are not intended to limit the number of their objects.

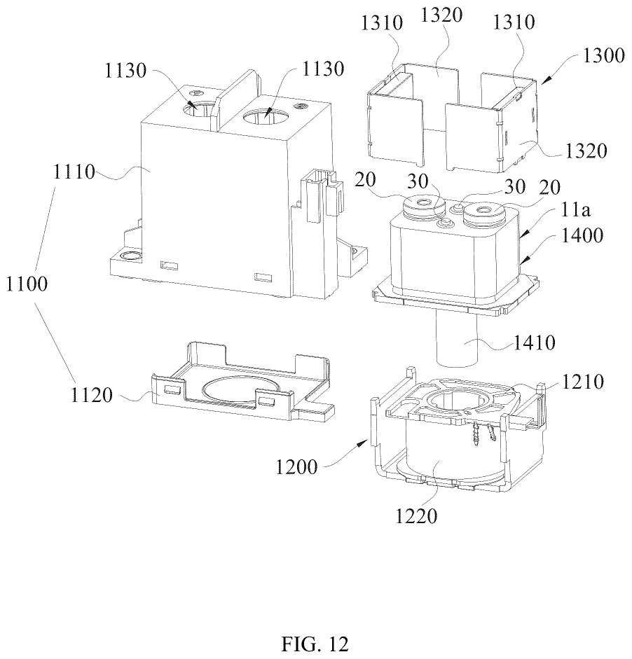

As shown in FIG. 12, FIG. 12 illustrates an exploded schematic diagram of the relay according to an embodiment of the present disclosure. The relay includes a housing 1100, an electromagnet unit 1200, an arc extinguishing unit 1300, and a sealing unit 1400. The sealing unit 1400 is disposed inside the housing 1100, and the top of the static contact terminal 20 of the sealing unit 1400 is exposed on the outer surface of the housing 1100 through the exposure hole 1130 of the housing 1100. Both the electromagnet unit 1200 and the arc extinguishing unit 1300 are arranged inside the housing 1100.

As an example, the housing 1100 includes a first housing 1110 and a second housing 1120, which are snap-fitted together to form a chamber for accommodating the electromagnet unit 1200, the arc extinguishing unit 1300, and the sealing unit 1400.

The arc extinguishing unit 1300 is used to extinguish arcs generated between the static contact terminal 20 of the sealing unit 1400 and the movable contact piece 54.

As an example, the arc extinguishing unit 1300 includes two arc extinguishing magnets 1310. The arc extinguishing magnets 1310 may be permanent magnets, and each arc extinguishing magnet 1310 may be generally cuboid-shaped. The two arc extinguishing magnets 1310 are respectively arranged on both sides of the sealing unit 1400 and are oppositely positioned along the length direction D2 of the movable contact piece 54.

By arranging two oppositely positioned arc extinguishing magnets 1310, a magnetic field can be formed around the static contact terminal 20 and the movable contact piece 54. Therefore, arcs generated between the static contact terminal 20 and the movable contact piece 54 will be elongated in opposite directions under the influence of the magnetic field, achieving arc extinguishing.

The arc extinguishing unit 1300 further includes two yoke clips 1320, which are correspondingly positioned with the two arc extinguishing magnets 1310. Moreover, the two yoke clips 1320 surround the sealing unit 1400 and the two arc extinguishing magnets 1310. By designing the yoke clips 1320 to surround the arc extinguishing magnets 1310, the diffusion of the magnetic field generated by the arc extinguishing magnets 1310 can be prevented, ensuring effective arc extinguishing. The yoke clips 1320 are made of soft magnetic materials, which may include but are not limited to iron, cobalt, nickel, and their alloys.

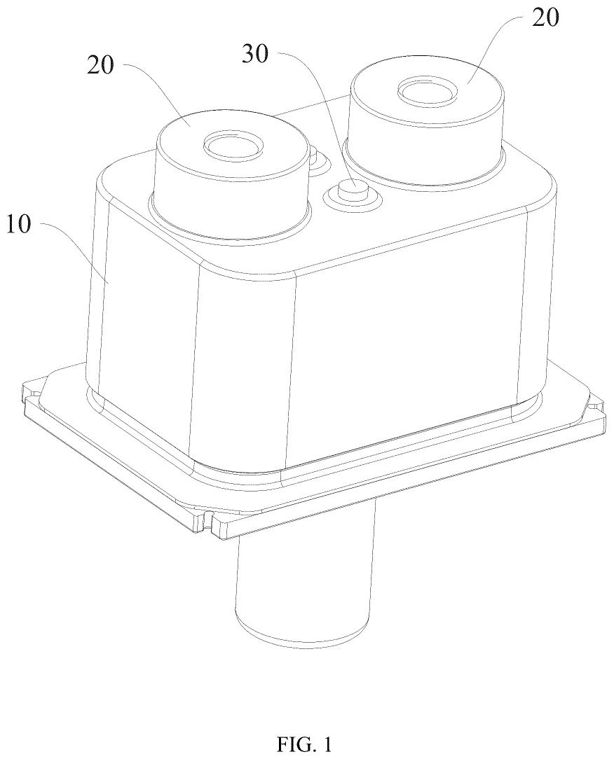

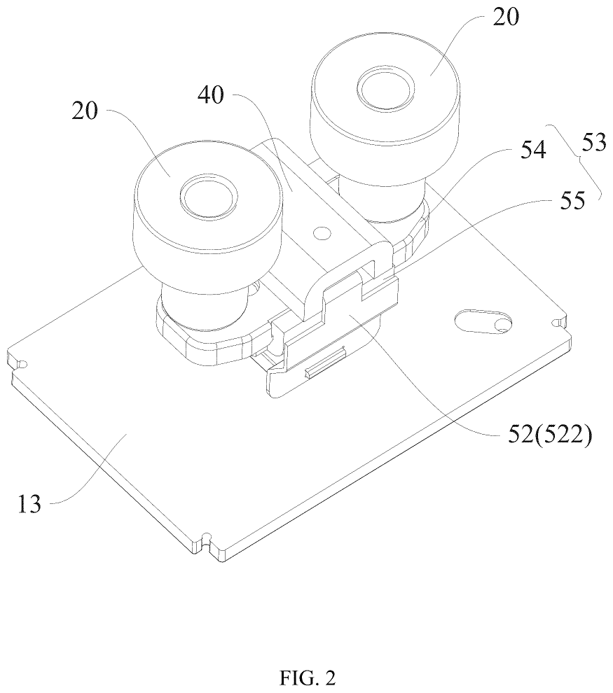

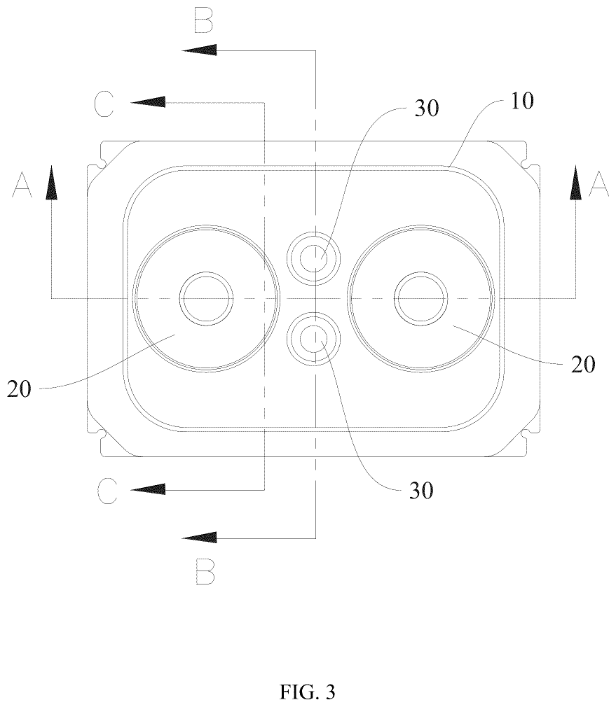

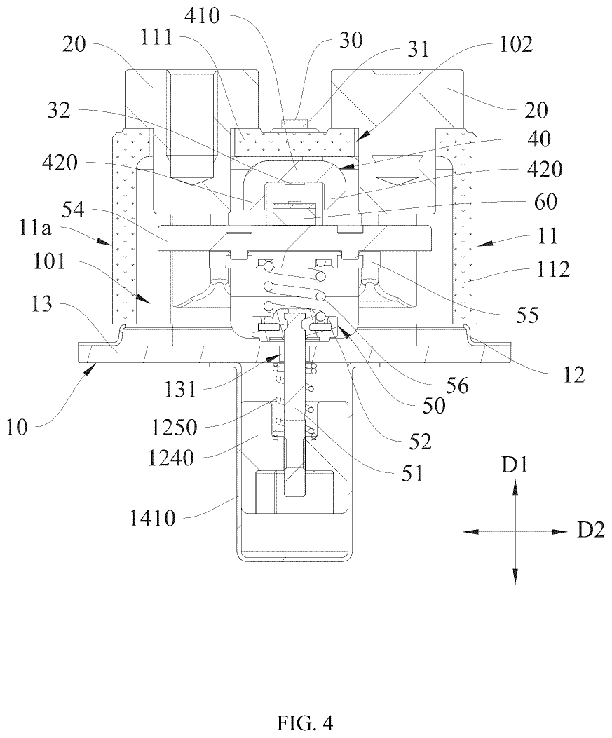

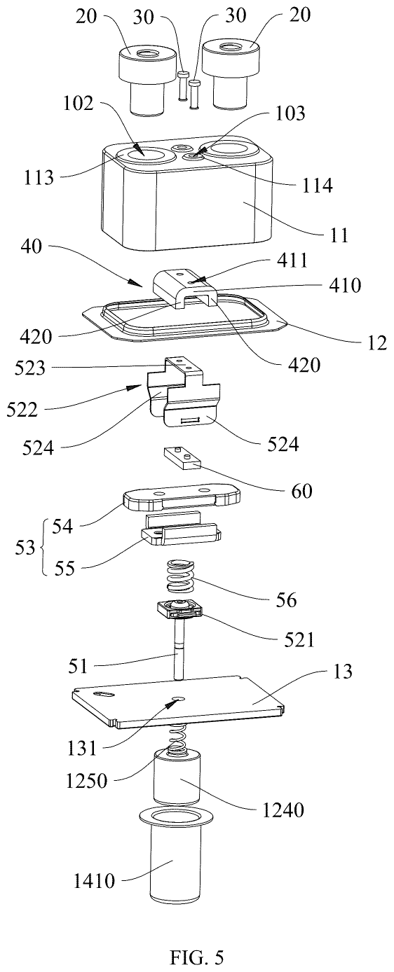

As shown in FIGS. 1 to 5, FIG. 1 illustrates a perspective view of the relay according to the first embodiment of the present disclosure. FIG. 2 illustrates a schematic view of FIG. 1 with the ceramic cover 11 and the frame member 12 removed. FIG. 3 illustrates a top view of FIG. 1. FIG. 4 illustrates a cross-sectional view along line A-A in FIG. 3. FIG. 5 illustrates an exploded view of FIG. 1.

The sealing unit 1400 of the embodiment of the present disclosure includes a contact container 10, a pair of static contact terminals 20, a first magnetizer 40, a push rod assembly 50, a movable contact assembly 53, and an elastic member 56.

It should be understood that the terms “include” and “have” and any variations thereof in the embodiments of the present disclosure are intended to cover non-exclusive inclusion. For example, a process, method, system, product, or device that includes a series of steps or units is not limited to the listed steps or units but may optionally include steps or units not listed, or other inherent steps or components of these processes, methods, products, or devices.

The contact container 10 has a contact chamber 101 inside. The contact container 10 may include an insulating cover 11a and a yoke plate 13. The insulating cover 11a covers one side of the yoke plate 13. The insulating cover 11a and the yoke plate 13 together enclose the contact chamber 101.

The insulating cover 11a includes a ceramic cover 11 and a frame member 12. The ceramic cover 11 is connected to the yoke plate 13 through the frame member 12. The frame member 12 may be a ring-shaped metal component, such as iron-nickel alloy, with one end connected to the opening edge of the ceramic cover 11, for example, by laser welding, brazing, resistance welding, or adhesive bonding. The other end of the frame member 12 is connected to the yoke plate 13, also by methods such as laser welding, brazing, resistance welding, or adhesive bonding. By providing the frame member 12 between the ceramic cover 11 and the yoke plate 13, the connection between the ceramic cover 11 and the yoke plate 13 is facilitated.

The ceramic cover 11 includes a top wall 111 and a side wall 112, with one end of the side wall 112 connected around the perimeter of the top wall 111, and the other end connected to the yoke plate 13 through the frame member 12. In this embodiment, the other end of the side wall 112 is connected to the yoke plate 13 through the frame member 12.

The contact container 10 also has a pair of first through-holes 102 and a second through-hole 103, both communicating with the contact chamber 101. The first through-holes 102 are for the static contact terminals 20 to pass through, and the second through-hole 103 is for a connector 30 to pass through.

As an example, the first through-holes 102 and the second through-hole 103 are both provided in the top wall 111 of the ceramic cover 11. The second through-hole 103 may be located between the two first through-holes 102, meaning the connector 30 is positioned between the pair of static contact terminals 20.

The number of second through-holes 103 may be two, for two connectors 30 to pass through, but this is not limiting.

The pair of static contact terminals 20 are connected to the contact container 10, with at least part of each static contact terminal 20 located inside the contact chamber 101. One of the pair of static contact terminals 20 serves as the current input terminal, and the other serves as the current output terminal.

The pair of static contact terminals 20 pass through the pair of first through-holes 102 in one-to-one correspondence and are connected to the top wall 111 of the ceramic cover 11, for example, by welding.

The bottom of the static contact terminal 20 serves as the static contact, which may be integrally or separately provided at the bottom of the static contact terminal 20.

The first magnetizer 40 is arranged inside the contact chamber 101 and is fixed relative to the contact container 10. The first magnetizer 40 includes a connecting portion 410 and a magnetic portion 420 connected to the connecting portion 410. The first magnetizer 40 is fixed relative to the contact container 10 through the connecting portion 410, and the magnetic portion 420 is used to form a magnetic circuit with the third magnetizer 55.

The push rod assembly 50 is movably disposed relative to the contact container 10 along the movement direction D1. The push rod assembly 50 includes a push rod 51, a support seat 52, and a second magnetizer 60. The push rod 51 is movably disposed relative to the contact container 10 along the axial direction of the push rod 51 (i.e., along the movement direction D1). The support seat 52 is fixed at one axial end of the push rod 51 and at least partially extends into the contact chamber 101. The second magnetizer 60 is fixedly disposed at the support seat 52. Along the axial direction of the push rod 51, the second magnetizer 60 is offset from the magnetic portion 420 and corresponds to the connecting portion 410.

It should be noted that the offset between the second magnetizer 60 and the magnetic portion 420 along the axial direction of the push rod 51 can be understood as: along the axial direction of the push rod 51, the orthographic projection of the second magnetizer 60 on the movable contact piece 54 does not overlap with the orthographic projection of the magnetic portion 420 on the movable contact piece 54. The correspondence between the second magnetizer 60 and the connecting portion 410 can be understood as: along the axial direction of the push rod 51, the orthographic projection of the second magnetizer 60 on the movable contact piece 54 at least partially overlaps with the orthographic projection of the connecting portion 410 on the movable contact piece 54.

As an example, the second magnetizer 60 and the support seat 52 may be fixed by riveting, but this is not limiting.

The yoke plate 13 has a third through-hole 131, which penetrates through two opposite sides of the yoke plate 13 along its thickness direction and communicates with the contact chamber 101 of the contact container 10. The push rod 51 is movably inserted through the third through-hole 131.

Of course, in other embodiments, the push rod assembly 50 may also adopt other structures, which will not be listed here.

The movable contact assembly 53 is movably disposed relative to the push rod assembly 50 along the axial direction of the push rod 51, between a first position closer to the static contact terminals 20 and a second position farther from the static contact terminals 20. The movable contact assembly 53 includes a movable contact piece 54 and a third magnetizer 55. The first magnetizer 40 and the second magnetizer 60 are located at the side of the movable contact piece 54 facing the static contact terminals 20, and along the axial direction of the push rod 51, the third magnetizer 55 is fixedly disposed at the side of the movable contact piece 54 facing away from the first magnetizer 40 and the second magnetizer 60. In other words, along the thickness direction of the movable contact piece 54 (i.e., along the movement direction D1), the first magnetizer 40 and the second magnetizer 60 are located at one side of the movable contact piece 54, and the third magnetizer 55 is located at the other side. The distance between the third magnetizer 55 and the connecting portion 410 is greater than the distance between the third magnetizer 55 and the magnetic portion 420.

It should be noted that the “first position” and “second position” in the movable connection of the movable contact assembly 53 relative to the push rod assembly 50 along the axial direction of the push rod 51 refer to the relative positions of the movable contact assembly 53 and the push rod assembly 50.

Specifically, when the electromagnet unit 1200 is energized, it drives the push rod 51, the support seat 52, and the movable contact assembly 53 to move together toward the static contact terminals 20. When the movable contact assembly 53 contacts the static contact terminals 20, the movable contact assembly 53 is stopped by the static contact terminals 20, while the push rod 51 and the support seat 52 continue to move upward until the overtravel process is completed. During the overtravel process, relative movement occurs between the movable contact assembly 53 and the push rod assembly 50.

During the overtravel process, if the movable contact assembly 53 is defined as fixed, the push rod assembly 50 will move upward relative to the movable contact assembly 53. Conversely, if the push rod assembly 50 is defined as fixed, the movable contact assembly 53 will move downward relative to the push rod assembly 50.

Thus, when the movable contact assembly 53 is separated from the static contact terminals 20 or just makes contact with them, the movable contact assembly 53 is in the first position relative to the push rod assembly 50, meaning the movable contact assembly 53 is closer to the static contact terminals 20. During the overtravel process, the movable contact assembly 53 moves downward relative to the push rod assembly 50, i.e., away from the static contact terminals 20, until it reaches the second position. When the movable contact assembly 53 moves to the second position relative to the push rod assembly 50, the overtravel process is completed. At this point, the compression of the elastic member 56 reaches its maximum.

From this, it can be seen that when the movable contact assembly 53 is in the first position relative to the push rod assembly 50, it can be considered that the movable contact assembly 53 is either separated from or just making contact with the static contact terminals 20. When the movable contact assembly 53 is in the second position relative to the push rod assembly 50, the overtravel process is completed.

As an example, the third magnetizer 55 and the movable contact piece 54 may be fixed by riveting, but this is not limiting.

It should be understood that the first magnetizer 40, second magnetizer 60, and third magnetizer 55 can all be made of materials such as iron, cobalt, nickel, and their alloys.

In one embodiment, the second magnetizer 60 may be linear shape, while the first magnetizer 40 and third magnetizer 55 may be U-shaped, but this is not limiting.

It should be understood that the first magnetizer 40, second magnetizer 60, and third magnetizer 55 can be designed to include multiple stacked magnetic sheets as needed.

The two ends of the movable contact piece 54 are used to contact the bottoms of the pair of static contact terminals 20, achieving contact closure. The two ends of the movable contact piece 54 along its length direction D2 can serve as movable contacts. The movable contacts at the ends of the movable contact piece 54 may protrude from other parts of the movable contact piece 54 or be flush with them.

It should be understood that the movable contacts may be integrally or separately provided at the two ends of the movable contact piece 54 along its length direction D2.

The elastic member 56 is located between the movable contact assembly 53 and the support seat 52, used to apply an elastic force to the movable contact assembly 53 toward the first position.

As an example, the elastic member 56 may be a spring, but this is not limiting.

In one embodiment, one end of the elastic member 56 abuts against the support seat 52, and the other end abuts against the third magnetizer 55 of the movable contact assembly 53.

Of course, in other embodiments, a through-hole may be provided in the third magnetizer 55, and the elastic member 56 may pass through this through-hole to abut against the movable contact piece 54.

The support seat 52 includes a base 521 and a bracket 522. The base 521 is connected to one axial end of the push rod 51, and the bracket 522 is connected to the base 521. The second magnetizer 60 is connected to the inner wall surface of the bracket 522, and the movable contact piece 54 and third magnetizer 55 are movably arranged between the base 521 and the bracket 522. One end of the elastic member 56 abuts against the base 521, and the other end abuts against the third magnetizer 55.

In one embodiment, the bracket 522 may be inverted U-shaped and snap-fitted with the base 521. The base 521 and bracket 522 enclose a chamber for accommodating the movable contact assembly 53 and the elastic member 56.

The bracket 522 may include a top portion 523 and two side portions 524, with the two side portions 524 connected to the sides of the top portion 523 and extending from the top portion 523 toward the base 521, forming the inverted U-shape. The ends of the two side portions 524 away from the top portion 523 are connected to the base 521. The space between the two side portions 524 allows the movable contact piece 54 and third magnetizer 55 to pass through and move.

The second magnetizer 60 is connected to the inner wall surface of the top portion 523. When the movable contact piece 54 is not in contact with or just makes contact with the static contact terminals 20, the movable contact piece 54 abuts against the second magnetizer 60 under the elastic force of the elastic member 56. During the overtravel process, the static contact terminals 20 stop the movable contact assembly 53 (the movable contact piece 54 and third magnetizer 55), keeping it stationary, while the push rod 51 drives the support seat 52 and second magnetizer 60 to continue moving upward. At this point, the movable contact assembly 53 and base 521 together compress the elastic member 56.

It should be understood that in other embodiments, the second magnetizer 60 may not be fixed to the bracket 522 of the support seat 52 but instead fixed to one end of the push rod 51. Specifically, the movable contact assembly 53 may have a through-hole, and the push rod 51 passes through this through-hole, with the second magnetizer 60 fixed to one end of the push rod 51.

The sealing unit 1400 further includes a metal cover 1410, which is connected to the side of the yoke plate 13 opposite to the insulating cover 11a and covers the third through-hole 131 on the yoke plate 13. The metal cover 1410 and yoke plate 13 enclose a chamber for accommodating the static iron core and movable iron core 1240 of the electromagnet unit 1200, which will be described in detail below.

As shown in FIGS. 4 and 12, the electromagnet unit 1200 includes a bobbin 1210, a coil 1220, a static iron core (not shown in the figure), a movable iron core 1240, and a reset member 1250. The bobbin 1210 is hollow and cylindrical, made of insulating material. The metal cover 1410 is inserted inside the bobbin 1210. The coil 1220 surrounds the bobbin 1210. The static iron core is fixed inside the metal cover 1410, with part of it extending into the third through-hole 131. The static iron core has a perforation corresponding to the position of the third through-hole 131, allowing the push rod 51 to pass through. The movable iron core 1240 is movably arranged inside the metal cover 1410 and is positioned opposite to the static iron core. The movable iron core 1240 is connected to the push rod 51, and when the coil 1220 is energized, the movable iron core 1240 is attracted to the static iron core. The movable iron core 1240 and push rod 51 may be connected by screwing, riveting, welding, or other methods.

The reset member 1250 is located inside the metal cover 1410 and is positioned between the static iron core and the movable iron core 1240. It is used to reset the movable iron core 1240 when the coil 1220 is de-energized. The reset member 1250 may be a spring and is sleeved around the push rod 51.

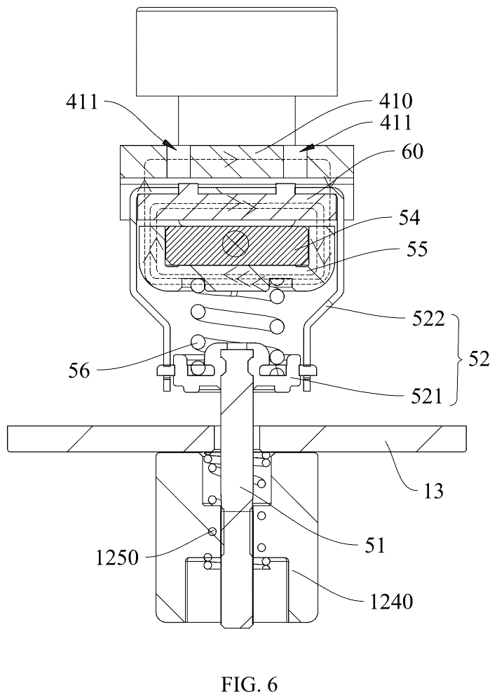

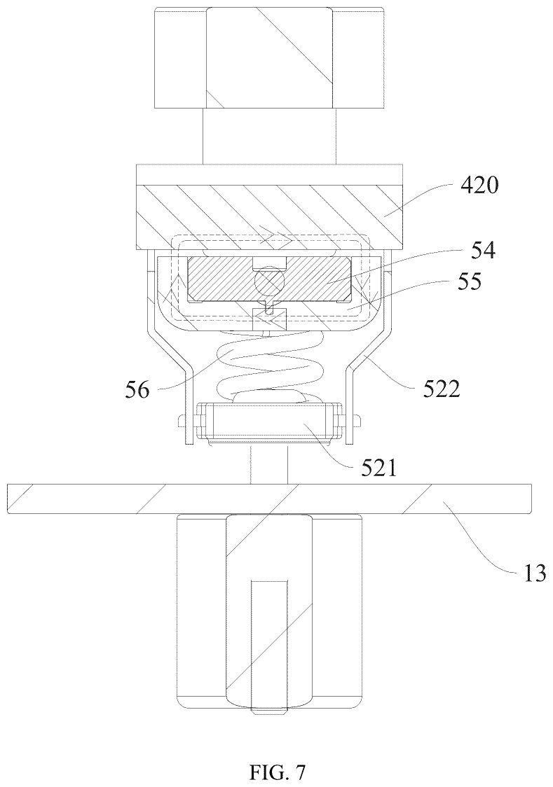

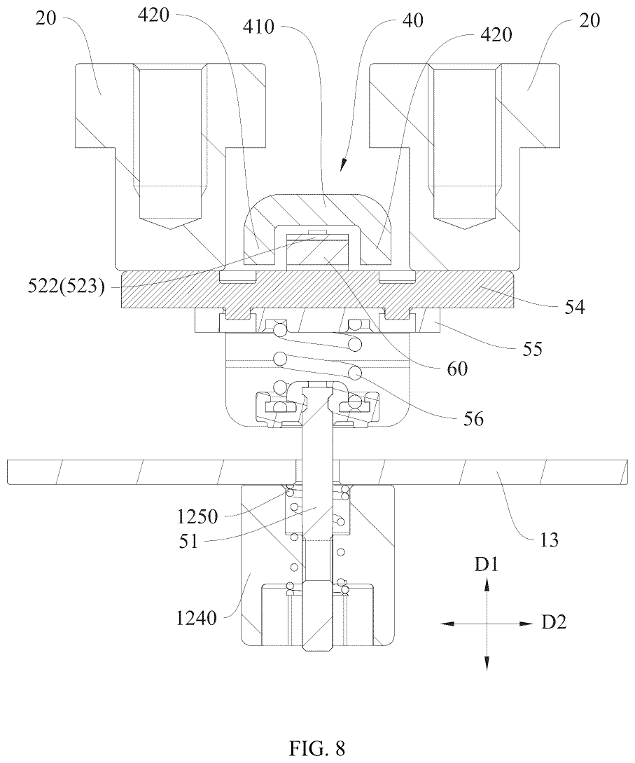

As shown in FIGS. 6 to 8, FIG. 6 illustrates a cross-sectional view along line B-B in FIG. 3, with the ceramic cover, frame member, and connector removed, and overtravel is completed. FIG. 7 illustrates a cross-sectional view along line C-C in FIG. 3, with the ceramic cover, frame member, and connector removed, and overtravel is completed. FIG. 8 illustrates a cross-sectional view along line A-A in FIG. 3, with the ceramic cover, frame member, and connector removed, and overtravel is completed.

It should be noted that FIGS. 6 to 8 show the state after overtravel is completed. In this state, the movable contact assembly 53 can be considered to be in the second position relative to the push rod assembly 50.

As shown in FIGS. 6 and 7, a first magnetic circuit is formed between the first magnetizer 40 and the third magnetizer 55, generating a magnetic attraction force between them. A second magnetic circuit is formed between the second magnetizer 60 and the third magnetizer 55, generating a magnetic attraction force between them. Since the first magnetizer 40 is fixed relative to the contact container 10, a fixed-type anti-short-circuit structure is formed between the first magnetizer 40 and the third magnetizer 55 during a short-circuit current, with the holding force provided by the contact container 10. Since the second magnetizer 60 is fixed to the support seat 52 of the push rod assembly 50, a follower-type anti-short-circuit structure is formed between the second magnetizer 60 and the third magnetizer 55 during a short-circuit current, with the holding force provided by the coil 1220 of the relay. Under the premise of a constant driving force from the coil 1220, the dual anti-short-circuit structure of this embodiment effectively enhances the upper limit of short-circuit current resistance.

It should be noted that, as shown in FIG. 8, the second magnetizer 60 is offset from the magnetic portion 420 along the axial direction of the push rod 51, ensuring that the magnetic circuits formed between the magnetic portion 420 and the third magnetizer 55 and between the second magnetizer 60 and the third magnetizer 55 do not interfere with each other. This ensures that the magnetic attraction forces of the magnetic portion 420 and the second magnetizer 60 do not affect each other, maintaining the anti-short-circuit effect.

Additionally, the distance between the third magnetizer 55 and the connecting portion 410 of the first magnetizer 40 is greater than the distance between the third magnetizer 55 and the magnetic portion 420 of the first magnetizer 40. It should be understood that magnetic flux primarily flows through the magnetic circuit with the smaller magnetic spacing. Therefore, as shown in FIGS. 6 and 7, when a short-circuit current flows through the movable contact piece 54, most of the magnetic flux flows between the third magnetizer 55 and the magnetic portion 420 and between the third magnetizer 55 and the second magnetizer 60, with only a small amount of magnetic flux flowing between the third magnetizer 55 and the connecting portion 410. Thus, although the second magnetizer 60 and the connecting portion 410 are aligned along the axial direction of the push rod 51 (i.e., their projections on the movable contact piece 54 overlap), the magnetic flux primarily flows through the magnetic portion 420 and second magnetizer 60, with minimal magnetic flux flows through the connecting portion 410. As a result, the magnetic attraction force between the connecting portion 410 and the second magnetizer 60 only slightly weakens the overall magnetic attraction force between the first magnetizer 40 and the third magnetizer 55, without affecting the anti-short circuit capability.

Notably, along the axial direction of the push rod 51, the connecting portion 410 of the first magnetizer 40 and the second magnetizer 60 are aligned, while the magnetic portion 420 of the first magnetizer 40 and the second magnetizer 60 are offset. This design ensures that the first magnetizer 40 does not excessively occupy space along the direction perpendicular to the axial direction of the push rod 51, which is beneficial for reducing the volume of the relay.

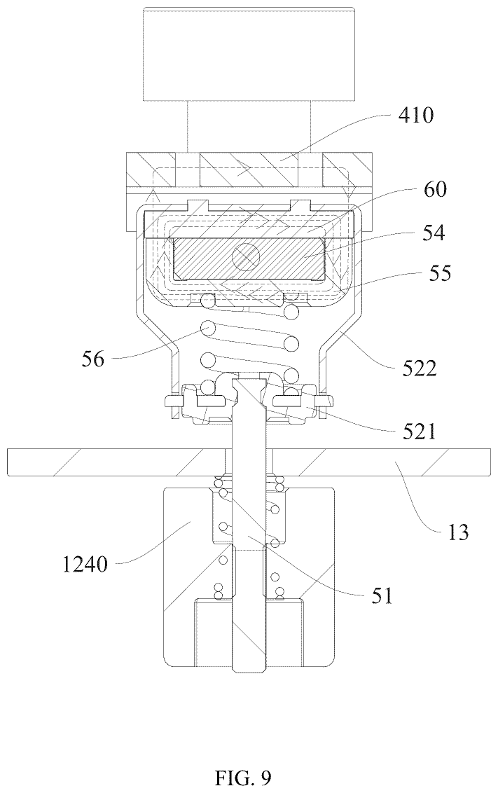

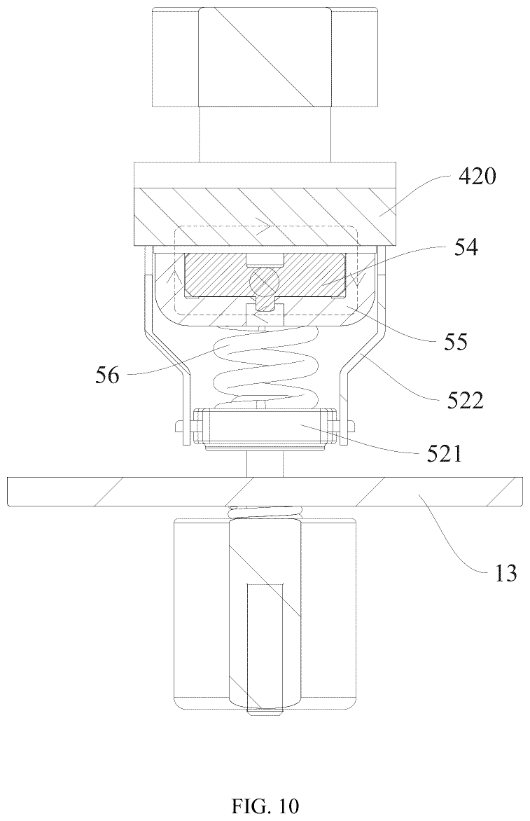

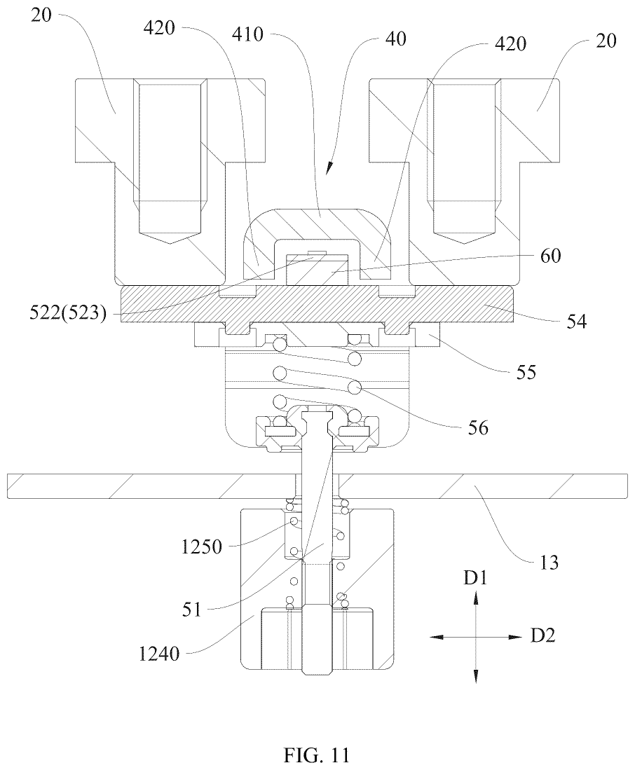

As shown in FIGS. 9 to 11, FIG. 9 illustrates a cross-sectional view along line B-B in FIG. 3, with the ceramic cover, the frame member, and connector removed, and when the movable contact piece 54 just contacts or separates from the static contact terminals 20. FIG. 10 illustrates a cross-sectional view along line C-C in FIG. 3, with the ceramic cover, frame member, and connector removed, and when the movable contact piece 54 just contacts or separates from the static contact terminals 20. FIG. 11 illustrates a cross-sectional view along line A-A in FIG. 3, with the ceramic cover, frame member, and connector removed, and when the movable contact piece 54 just contacts or separates from the static contact terminals 20.

It should be noted that FIGS. 9 to 11 show the state when the movable contact piece 54 just contacts or separates from the static contact terminals 20. In this state, the movable contact assembly 53 can be considered to be in the first position relative to the push rod assembly 50.

To illustrate the effect of the relay in enhancing anti-short circuit while meeting the requirements for overload current breaking, the state shown in FIGS. 9 to 11, where the movable contact piece 54 just separates from the static contact terminals 20, is used as an example.

When the coil 1220 of the relay is de-energized, under the action of the movable iron core 1240, the push rod assembly 50 moves downward relative to the static contact terminals 20, meaning the movable contact assembly 53 moves from the second position to the first position relative to the push rod assembly 50, transitioning from FIG. 7 to FIG. 10. During this movement, the magnetic spacing between the second magnetizer 60 and the third magnetizer 55 gradually decreases. When the movable contact assembly 53 reaches the first position, the second magnetizer 60 contacts the movable contact assembly 53, and the magnetic gap between the second magnetizer 60 and the third magnetizer 55 becomes smaller than that between the magnetic portion 420 and the third magnetizer 55.

It should be understood that most of the magnetic flux flows through the magnetic circuit with the smaller magnetic spacing, i.e., most of the magnetic flux flows through the magnetic circuit formed between the second magnetizer 60 and the third magnetizer 55. For example, as shown in FIG. 10, one magnetic flux line is formed between the magnetic portion 420 of the first magnetizer 40 and the third magnetizer 55. As shown in FIG. 9, three magnetic flux lines are formed between the second magnetizer 60 and the third magnetizer 55.

At this point, the magnetic attraction force between the second magnetizer 60 and the third magnetizer 55 is large, while the magnetic attraction force between the magnetic portion 420 and the third magnetizer 55 is small. Since the second magnetizer 60 contacts the movable contact assembly 53, the magnetic attraction force between the second magnetizer 60 and the third magnetizer 55 becomes an internal force and does not affect the breaking of the movable contact piece 54. Therefore, the movable contact piece 54 only needs to overcome the smaller magnetic attraction force between the magnetic portion 420 and the third magnetizer 55 to achieve breaking. Additionally, although the second magnetizer 60 and the connecting portion 410 are aligned along the axial direction of the push rod 51 (i.e., their projections on the movable contact piece 54 overlap), most of the magnetic flux flows through the magnetic portion 420 and the second magnetizer 60, with only a small amount flowing through the connecting portion 410. Thus, the connecting portion 410 and the second magnetizer 60 only slightly weaken the overall magnetic attraction force between the first magnetizer 40 and the third magnetizer 55, which is beneficial for breaking. Furthermore, the magnetic flux lines of the connecting portion 410 and the second magnetizer 60 are in the same direction, creating a repulsive force between them, further aiding breaking.

From this, it can be seen that the first magnetizer 40 is fixed relative to the contact container 10, and a fixed-type anti-short-circuit structure is formed between the magnetic portion 420 and the third magnetizer 55. The second magnetizer 60 is fixed to the support seat 52 of the push rod assembly 50, forming a follower-type anti-short-circuit structure with the third magnetizer 55. The magnetic portion 420 of the first magnetizer 40 and the second magnetizer 60 are offset along the axial direction of the push rod 51, while the connecting portion 410 of the first magnetizer 40 and the second magnetizer 60 are aligned along the axial direction of the push rod 51. The relay of the embodiment of the present disclosure meets the requirements for anti-short circuit and limit breaking capability while ensuring that the first magnetizer 40 does not excessively occupy space along the direction perpendicular to the axial direction of the push rod 51, which is beneficial for reducing the volume of the relay.

It should be understood that when the movable contact assembly 53 is in the first position relative to the push rod assembly 50, the second magnetizer 60 and the third magnetizer 55 may either be in direct contact or have a gap between them.

In this embodiment, when the movable contact assembly 53 is in the first position relative to the push rod assembly 50, the second magnetizer 60 and the third magnetizer 55 are in direct contact. In this case, most of the magnetic flux flows through the magnetic circuit formed between the second magnetizer 60 and the third magnetizer 55, while a smaller portion flows through the magnetic circuit formed between the magnetic portion 420 and the third magnetizer 55. The magnetic attraction force between the magnetic portion 420 and the third magnetizer 55 is relatively small, which is more conducive to the separation of the movable contact piece 54 and the static contact terminals 20.

As shown in FIGS. 4 and 5, the magnetic portion 420 and the connecting portion 410 are of an integrated structure, and the magnetic portion 420 extends from the connecting portion 410 toward the movable contact piece 54.

In this embodiment, the first magnetizer 40 includes two oppositely arranged magnetic portions 420, which are respectively connected to the two opposite sides of the connecting portion 410 along the length direction D2 of the movable contact piece 54, forming an inverted U-shape for the first magnetizer 40.

Of course, in other embodiments, the first magnetizer 40 may also be L-shaped, with one side serving as the connecting portion 410 and the other side serving as the magnetic portion 420.

As shown in FIGS. 4 and 5, the relay of the embodiment of the present disclosure further includes a connector 30, which passes through the second through-hole 103 and includes a first end 31 and a second end 32. The first end 31 is connected to the contact container 10, and the second end 32 is connected to the first magnetizer 40.

In the relay of the embodiment of the present disclosure, the connecting portion 410 of the first magnetizer 40 is connected to the contact container 10 through the connector 30 rather than directly, making the connection process unobstructed and visible, which is both convenient and ensures reliability.

In an embodiment, the connecting portion 410 has a connecting hole 411, and the connector 30 passes through the connecting hole 411.

Furthermore, both the first through-hole 102 and the second through-hole 103 are provided in the top wall 111 of the ceramic cover 11, and the first end 31 of the connector 30 is connected to the outer surface of the top wall 111.

On the outer surface of the top wall 111, a first metallization layer 113 is provided around the periphery of the first through-hole 102, and a second metallization layer 114 is provided around the periphery of the second through-hole 103. The static contact terminals 20 are welded to the top wall 111 through the first metallization layer 113, and the first end 31 of the connector 30 is welded to the top wall 111 through the second metallization layer 114.

Compared to the inner surface of the ceramic cover 11, the outer surface of the top wall 111 is easier to form a welding plane. Additionally, since the top wall 111 of the ceramic cover 11 needs to accommodate the static contact terminals 20, and welding the static contact terminals 20 to the top wall 111 also requires a metallization layer around the first through-hole 102, the second metallization layer 114 around the second through-hole 103 can be processed simultaneously. Therefore, by welding the connector 30 to the outer surface of the top wall 111, only the outer surface needs to be metallized, simplifying the processing steps.

The connecting portion 410 of the first magnetizer 40 is spaced apart from the inner surface of the top wall 111. By spacing the connecting portion 410 from the inner surface of the top wall 111, a gap is formed between them. Since the connecting portion 410 does not directly contact the inner surface of the top wall 111, the arrangement of the first magnetizer 40 does not affect the creepage distance of the pair of static contact terminals 20.

The top wall 111 and the side wall 112 are separate structures and are connected by welding.

It should be understood that by designing the ceramic cover 11 with separate top wall 111 and side wall 112, it is easier to connect the connector 30 to the top wall 111. Of course, the top wall 111 and the side wall 112 can also be connected by adhesive bonding.

Specifically, since the top wall 111 is plate-shaped, it is easier to process the first through-hole 102, second through-hole 103, first metallization layer 113, and second metallization layer 114 on the top wall 111. Furthermore, the plate-shaped structure also makes it easier to weld the connector 30 and the top wall 111, as well as the static contact terminals 20 and the top wall 111.

Of course, the top wall 111 and the side wall 112 can also be an integrated structure.

The connection between the second end 32 of the connector 30 and the first magnetizer 40 can be achieved in various ways, such as welding, riveting, or adhesive bonding.

Of course, in other embodiments, the first magnetizer 40 can be fixed relative to the contact container 10 not only by is fixed to the ceramic cover 11 through the connector 30 but also by is fixed to a fixed frame. Specifically, the relay further includes a fixed frame, which is located inside the contact chamber 101 and fixed to the yoke plate 13. The connecting portion 410 of the first magnetizer 40 is fixed to this fixed frame.

At least one embodiment of the above disclosure has the following advantages or beneficial effects:

In the relay of the embodiment of the present disclosure, the first magnetizer is fixed relative to the contact container, and a fixed-type anti-short-circuit structure is formed between the magnetic portion of the first magnetizer and the third magnetizer. A follower-type anti-short-circuit structure is formed between the second magnetizer of the push rod assembly and the third magnetizer. The magnetic portions of the first magnetizer and the second magnetizer are offset along the axial direction of the push rod, while the connecting portion of the first magnetizer and the second magnetizer are aligned along the axial direction of the push rod. The relay of the embodiment of the present disclosure not only meets the requirements for anti-short circuit and limit breaking capability, but also ensures that the first magnetizer does not excessively occupy space along the direction perpendicular to the axial direction of the push rod, which is beneficial for reducing the volume of the relay.

It should be understood that the present disclosure is not limited to the detailed structure and arrangement of the components described in this specification. The present disclosure can have other embodiments and can be implemented and executed in various ways. The aforementioned variations and modifications fall within the scope of the present disclosure. It should be understood that the present disclosure extends to all alternative combinations of two or more individual features mentioned or apparent in the text and/or drawings. All these different combinations constitute multiple alternative aspects of the present disclosure. The embodiments in this specification illustrate the best mode known for implementing the present disclosure and will enable those skilled in the art to utilize the present disclosure.

1. A relay, comprising:
a contact container having a contact chamber;
a pair of static contact terminals fixedly disposed relative to the contact container;
a first magnetizer located within the contact chamber; the first magnetizer comprises a connecting portion and a magnetic portion connected to the connecting portion, and the first magnetizer is fixed relative to the contact container through the connecting portion;
a push rod assembly, including a push rod and a second magnetizer; the push rod is movably disposed relative to the contact container along an axial direction of the push rod, and the second magnetizer is arranged at one end of the push rod; along the axial direction of the push rod, the second magnetizer is offset from the magnetic portion and corresponds to the connecting portion;
a movable contact assembly, movably disposed relative to the push rod assembly along the axial direction of the push rod, between a first position closer to the static contact terminals and a second position farther from the static contact terminals; the movable contact assembly comprises a movable contact piece and a third magnetizer; the first magnetizer and the second magnetizer are located at a side of the movable contact piece facing the static contact terminals, and along the axial direction of the push rod, the third magnetizer is fixedly disposed at a side of the movable contact piece facing away from the first magnetizer and the second magnetizer; the third magnetizer and the first magnetizer are configured to form a first magnetic circuit, and the third magnetizer and the second magnetizer are configured to form a second magnetic circuit; a distance between the third magnetizer and the connecting portion is greater than a distance between the third magnetizer and the magnetic portion.

2-15. (canceled)

16. The relay according to claim 1, wherein the pair of static contact terminals are connected to the contact container, at least a portion of each of the static contact terminals is located within the contact chamber.

17. The relay according to claim 1, further comprising an elastic member connected between the movable contact assembly and the push rod assembly, configured to apply an elastic force to the movable contact assembly toward the first position.

18. The relay according to claim 1, wherein the magnetic portion and the connecting portion are of an integrated structure, and the magnetic portion extends from the connecting portion toward the movable contact piece.

19. The relay according to claim 18, wherein the first magnetizer comprises two magnetic portions arranged oppositely, the two magnetic portions are respectively connected to two sides of the connecting portion along the length direction of the movable contact piece, forming the first magnetizer in an inverted U-shape.

20. The relay according to claim 1, wherein, when the movable contact assembly is in the first position, a magnetic gap between the magnetic portion and the third magnetizer is greater than a magnetic gap between the second magnetizer and the third magnetizer.

21. The relay according to claim 20, wherein, when the movable contact assembly is in the first position, the second magnetizer and the third magnetizer are in direct contact.

22. The relay according to claim 17, wherein the push rod assembly further comprises a support seat fixed at one end of the push rod along the axial direction of the push rod and at least partially extending into the contact chamber; the second magnetizer is fixed to the support seat, and the elastic member is arranged between the movable contact assembly and the support seat.

23. The relay according to claim 22, wherein the support seat comprises:
a base connected to one end of the push rod, the elastic member is arranged between the base and the movable contact assembly; and
a bracket connected to the base; the second magnetizer is connected to an inner wall surface of the bracket, and the movable contact piece and the third magnetizer are movably arranged within a space enclosed by the base and the bracket.

24. The relay according to claim 23, wherein the bracket comprises:
a top portion, the second magnetizer is connected to an inner wall surface of the top portion; and
two side portions respectively connected to two sides of the top portion and extending from the top portion toward the base; two ends of the two side portions away from the top portion are respectively connected to the base, and the two side portions, the top portion, and the base together form a space for the movable contact assembly to move.

25. The relay according to claim 1, wherein the contact container further comprises a pair of first through-holes and a second through-hole communicating with the contact chamber; the pair of static contact terminals respectively pass through the pair of first through-holes in one-to-one correspondence;
the relay further comprises a connector passed through the second through-hole, the connector comprises a first end and a second end, the first end is connected to the contact container, and the second end is connected to the connecting portion.

26. The relay according to claim 25, wherein the contact container comprises:
a yoke plate; and
an insulating cover comprising a top wall and a side wall, one end of the side wall is connected around the perimeter of the top wall, and another end of the side wall is connected to the yoke plate;
wherein the first through-holes and the second through-hole are provided in the top wall, and the first end of the connector is connected to an outer surface of the top wall.

27. The relay according to claim 26, wherein the insulating cover comprises a ceramic cover and a frame member, the ceramic cover comprises the top wall and the side wall, another end of the side wall is connected to the yoke plate through the frame member;
on an outer surface of the top wall, a first metallization layer is provided around a periphery of the first through-holes, and a second metallization layer is provided around a periphery of the second through-hole;
the static contact terminals are welded to the top wall through the first metallization layer, and the first end of the connector is welded to the top wall through the second metallization layer.

28. The relay according to claim 26, wherein the top wall and the side wall are of an integrated structure; or, the top wall and the side wall are separate structures.

29. The relay according to claim 25, wherein the connecting portion has a connecting hole, and the connector passes through the connection hole.

30. The relay according to claim 26, wherein the connecting portion is spaced apart from an inner surface of the top wall.

31. The relay according to claim 1, wherein the contact container comprises:
a yoke plate; and
an insulating cover connected to the yoke plate;
the relay further comprises a fixed frame located within the contact chamber and fixed to the yoke plate, and the connecting portion is fixed to the fixed frame.

32. The relay according to claim 16, wherein the contact container further comprises a pair of first through-holes and a second through-hole communicating with the contact chamber; the pair of static contact terminals respectively pass through the pair of first through-holes in one-to-one correspondence;
the relay further comprises a connector passed through the second through-hole, the connector comprises a first end and a second end, the first end is connected to the contact container, and the second end is connected to the connecting portion.

33. The relay according to claim 17, wherein the contact container further comprises a pair of first through-holes and a second through-hole communicating with the contact chamber; the pair of static contact terminals respectively pass through the pair of first through-holes in one-to-one correspondence;
the relay further comprises a connector passed through the second through-hole, the connector comprises a first end and a second end, the first end is connected to the contact container, and the second end is connected to the connecting portion.

34. The relay according to claim 18, wherein the contact container further comprises a pair of first through-holes and a second through-hole communicating with the contact chamber; the pair of static contact terminals respectively pass through the pair of first through-holes in one-to-one correspondence;
the relay further comprises a connector passed through the second through-hole, the connector comprises a first end and a second end, the first end is connected to the contact container, and the second end is connected to the connecting portion.
